(19) United States
(12) Patent Application Publication
(10) Pub. No.: US 2023/0001377 A1
(43) Pub. Date: Jan. 5, 2023

(54) UTRALIGHT HYDROGEN PRODUCTION REACTOR COMPRISING HIGH-EFFICIENCY COMPOSITE

(71) Applicant: Korea Institute of Science and Technology, Seoul (KR)

(72) Inventors: Young Suk JO, Seoul (KR); Arash BADAKHSH, Seoul (KR); Jun Young CHA, Seoul (KR); Young Cheon KIM, Seoul (KR); Hyang Soo JEONG, Seoul (KR); Yong Min KIM, Seoul (KR); Hyun Tae SOHN, Seoul (KR); Seong Cheol JANG, Seoul (KR); Sung Pil YOON, Seoul (KR); Suk Woo NAM, Seoul (KR); Taik Jin LEE, Seoul (KR); Chang Won YOON, Seoul (KR); Jong Hee HAN, Seoul (KR)

(21) Appl. No.: 17/897,686

(22) Filed: Aug. 29, 2022

Related U.S. Application Data
(63) Continuation of application No. PCT/KR2021/008340, filed on Jul. 1, 2021.

(30) Foreign Application Priority Data
Jul. 7, 2020 (KR) 10-2020-0083476

(51) Int. Cl. B01J 19/24; C01B 3/04; B01J 19/02; B01J 19/00

(52) U.S. Cl. CPC B01J 19/2415; C01B 3/047; B01J 19/02; B01J 19/0013; B01J 2219/0218; B01J 2219/029; B01J 2219/00155

(57) ABSTRACT

The present invention relates to a hydrogen production reactor comprising a high-efficiency composite having a high thermal conductivity and an antioxidant property. Specifically, the hydrogen production reactor comprises: a first region in which a combustion reaction of fuel occurs; a second region in which a hydrogen extraction reaction occurs; a metal substrate that partitions the first region and the second region; and a coating layer that comprises boron nitride (BN) and is formed on at least one surface of the metal substrate, wherein heat generated in the first region is transferred to the second region through the metal substrate.

### CROSS REFERENCE

This application is a continuation of International Patent Application No. PCT/KR2021/008340, filed Jul. 1, 2021, which claims the benefit of Korean Application No. 1020200083476, filed Jul. 7, 2020, each of which is incorporated herein by reference in their entirety for all purposes.

### TECHNICAL FIELD

The present invention relates to a hydrogen production reactor comprising a high-efficiency composite having a high thermal conductivity and an antioxidant property.

### BACKGROUND ART

Hydrogen has recently attracted attention as an eco-friendly and sustainable energy carrier capable of storing a large amount of renewable energy of 0.1 to 10 MWh per pressure tank or 0.1 to 100 GWh per liquid tank. At the same time, hydrogen energy is actively developed as an efficient energy system to replace the existing energy systems powered by fossil fuel that has a negative impact on the environment. Accordingly, hydrogen fuel cells are positioned as an eco-friendly system that is highly efficient and produces water (H₂O) as a byproduct.

Hydrogen has a very high energy density relative to weight (33.3 kWh·kg⁻¹) and has a low energy density relative to volume (2.97 Wh·L⁻¹, H₂ gas, 0° C., 1 atm). Thus, it is necessary to store hydrogen in an appropriate way so that the energy density relative to volume is increased. Therefore, to efficiently store hydrogen, physical hydrogen storage methods such as compressed hydrogen storage and liquefied hydrogen storage have been intensively studied in industry; however, these methods have problems in safety and energy loss. For this reason, a growing interest is focusing on chemical hydrogen storage methods capable of potentially storing a large amount of hydrogen in a reliable manner. Possible candidates for the chemical hydrogen storage methods may comprise methanol (CH₃OH), sodium borohydride (NaBH₄), ammonia borane (NH₃BH₃), formic acid (HCO₂H), and the like.

Meanwhile, since the chemical hydrogen storage methods involve chemical reactions, high heat transfer efficiency is required to increase catalytic reactivity. Thus, a reactor is preferably made of a material such as metal that has a high thermal conductivity. However, the metal is oxidized, and thus has a problem of poor durability. To avoid this problem, an anti-oxidation film such as ceramic is formed on the surface of the metal; however, this causes a problem of decreased thermal conductivity. Therefore, there is a need to improve a reactor used in the chemical hydrogen storage methods so that the reactor can perform heat transfer in a more efficient manner.

### DISCLOSURE OF INVENTION

### Technical Problem

An object of the present invention is to provide a hydrogen production reactor having excellent heat transfer efficiency.

In addition, an object of the present invention is to provide a hydrogen production reactor having excellent durability using a material that is stable and less reactive at a high temperature.

In addition, an object of the present invention is to provide a hydrogen production reactor having high durability due to an excellent antioxidant property.

In addition, an object of the present invention is to provide a hydrogen production reactor that has a reduced volume and requires a less amount of catalyst as compared with conventional ones.

The object of the present invention is not limited to the objects as mentioned above. The object of the present invention will become more clearly understood from the following description, and will be achieved by the means described in the claims and combinations thereof.

### Solution to Problem

A hydrogen production reactor according to an embodiment of the present invention may comprise a first region in which a combustion reaction of fuel occurs; a second region in which a hydrogen extraction reaction occurs; a metal substrate that partitions the first region and the second region; and a coating layer that comprises boron nitride (BN) and is formed on at least one surface of the metal substrate, wherein heat generated in the first region is transferred to the second region through the metal substrate.

The hydrogen production reactor may comprise a housing inside which the first region and the second region are provided; and a partition wall that partitions the first region and the second region, comprises the metal substrate, and is provided inside the housing.

The hydrogen production reactor may have a double-tube structure having an inner tube and an outer tube, wherein the inner tube comprises the first region and the outer tube comprises the second region.

The hydrogen production reactor may have a plurality of the inner tubes.

The fuel may comprise at least one selected from the group consisting of hydrogen, hydrocarbons, and combinations thereof.

The first region may be filled with a catalyst for the combustion reaction of the fuel.

The hydrogen extraction reaction may comprise at least one selected from the group consisting of methane reforming, methanol reforming, ammonia decomposition, liquid organic hydrogen carrier (LOHC) dehydrogenation, and combinations thereof.

The second region may be filled with a catalyst for the hydrogen extraction reaction.

A temperature in the second region may be 300° C. to 900° C.

The metal substrate may comprise at least one selected from the group consisting of copper (Cu), aluminum (Al), tungsten (W), iron (Fe), Inconel, and combinations thereof.

The coating layer may have a thickness of 1 μm to 10 μm.

The coating layer may further comprise a catalyst for the combustion reaction of the fuel or the hydrogen extraction reaction.

The catalyst may be applied onto the coating layer to form a catalyst layer.

The catalyst may be supported on the boron nitride of the coating layer.

The catalyst may comprise at least one catalytic metal selected from the group consisting of ruthenium (Ru), lanthanum (La), platinum (Pt), palladium (Pd), nickel (Ni), iron (Fe), cobalt (Co), and combinations thereof.

The hydrogen production reactor may further comprise a circulation flow channel for supplying hydrogen generated in the second region to the first region.

The hydrogen production reactor may further comprise a heat-insulating member for insulating the hydrogen production reactor from an outside thereof.

### Advantageous Effects of Invention

The hydrogen production reactor according to the present invention has very good heat transfer efficiency because heat transfer occurs through metal and boron nitride, each of which has a high thermal conductivity.

In addition, in the hydrogen production reactor according to the present invention, the surface of a metal is coated with boron nitride so that the hydrogen production reactor is stable and less reactive at a high temperature, thereby exhibiting very high durability.

In addition, in the hydrogen production reactor according to the present invention, the surface of a metal is coated with boron nitride, which makes it possible to prevent the metal from being oxidized.

In addition, the hydrogen production reactor according to the present invention has high heat transfer efficiency. Thus, in a case where this reactor is used, the reactor can have a reduced volume and require a less amount of catalyst as compared with conventional ones.

In addition, in the hydrogen production reactor according to the present invention, the surface of a metal, which is brittle to hydrogen, is coated with boron nitride so that molecular hydrogen does not permeate the metal. Accordingly, in a case where the hydrogen production reactor according to the present invention is used, it is possible to stably produce and extract hydrogen.

The effect of the present invention is not limited to the effects as mentioned above. It should be understood that the effect of the present invention comprises all effects that can be inferred from the following description.

### BRIEF DESCRIPTION OF DRAWINGS

FIG. 1 schematically illustrates a first embodiment of a hydrogen production reactor according to the present invention.

FIG. 2 schematically illustrates a second embodiment of a hydrogen production reactor according to the present invention.

FIG. 3 schematically illustrates a third embodiment of a hydrogen production reactor according to the present invention.

FIG. 4 schematically illustrates a metal substrate and a coating layer which are included in the hydrogen production reactor.

FIG. 5 schematically illustrates a metal substrate, a coating layer, and a catalyst layer which are included in the hydrogen production reactor.

FIG. 6 illustrates a hydrogen production reactor prepared in the Preparation Example of the present invention.

FIG. 7A illustrates a result obtained by performing scanning electron microscope (SEM) analysis on the outer surface of a copper tube included in the hydrogen production reactor of Preparation Example 1 of the present invention.

FIG. 7B illustrates a result obtained by performing scanning electron microscope (SEM) analysis on the inner surface of a copper tube included in the hydrogen production reactor of Preparation Example 1 of the present invention.

FIG. 8 illustrates results obtained by measuring ammonia conversion rates of the hydrogen production reactors in Experimental Example 1 of the present invention.

### BEST MODE FOR CARRYING OUT INVENTION

The above-described objects, other objects, features, and advantages of the present invention will be easily understood through the following preferred embodiments with reference to the accompanying drawings. However, the present invention is not limited to the embodiments described herein and may be embodied in other forms. Rather, the embodiments described herein are provided so that the disclosure can be thoroughly and completely understood and the spirit of the present invention can be sufficiently conveyed to those skilled in the art.

In describing each drawing, like reference numerals represent like elements. In the accompanying drawings, dimensions of the structures are enlarged as compared with their actual dimensions for clarity of the present invention. The terms “first”, “second”, and the like may be used to describe various elements; however, the elements should not be limited to such terms. These terms are used only for the purpose of distinguishing one element from another. For example, without departing from the scope of the present invention, a first element may be referred to as a second element, and similarly, the second element may also be referred to as the first element. The singular forms “a”, “an”, and “the” include plural referents unless the context clearly dictates otherwise.

As used herein, the term such as “comprises,” “comprising,” “includes,” “including,” “contains,” “containing,” “has,” or “having” should be understood to imply the inclusion of a stated feature, number, step, operation, element, or part, or combinations thereof, but not the exclusion of one or more other features, numbers, steps, operations, elements, or parts, or combinations thereof. In addition, when a part such as layer, film, region, or plate is said to be “on” another part, it includes not only a case where the part is “directly over” the other part but also a case where there is another part in between. Conversely, when a part such as layer, film, region, or plate is said to be “beneath” another part, it includes not only a case where the part is “directly under” the other part but also a case where there is another part in between.

Unless otherwise specified, it should be understood that all numbers, values, and/or expressions used herein, which represent quantities of ingredients, reaction conditions, polymer compositions, and blends, are modified by the term “about” in all cases, because such numbers are essentially approximations reflecting, among others, various uncertainties in the measurements which arise in obtaining those numbers. In addition, in a case where a numerical range is disclosed herein, such range is continuous, inclusive of both the minimum and maximum values of the range as well as all values between such minimum and maximum values, unless otherwise indicated. Furthermore, in a case where such range is expressed as integers, all integers between and including the minimum and maximum values of the range are included therein, unless otherwise indicated.

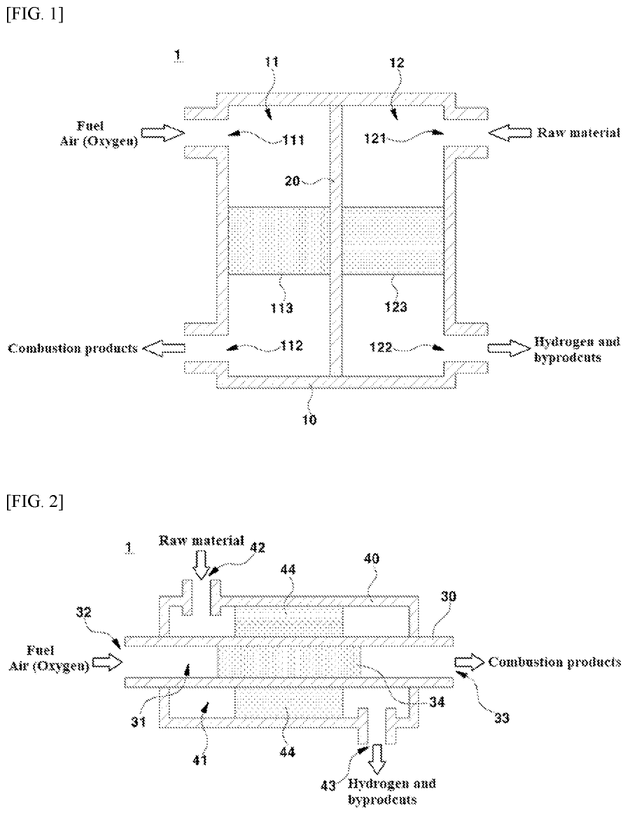

FIG. 1 illustrates a first embodiment of a hydrogen production reactor according to the present invention. Referring to this drawing, a hydrogen production reactor 1 comprises a housing 10 inside which a first region 11 and a second region 12 are provided, and a partition wall 20 that partitions the first region 11 and the second region 12 and is provided inside the housing 10.

The first region 11 is a space in which a combustion reaction of fuel occurs, and the second region 12 is a space in which a hydrogen extraction reaction of a raw material occurs.

Specifically, in the first region 11, fuel introduced through a fuel inlet 111 is combusted to generate heat. Combustion products generated by the combustion of the fuel are discharged to the outside through a fuel outlet 112.

The fuel may comprise at least one selected from the group consisting of hydrogen, hydrocarbons, and combinations thereof.

A method of combusting the fuel is not particularly limited, and the combustion may be performed by, for example, supplying the fuel and air (or oxygen) to a device (not shown) that is provided in the first region 11 and generates sparks, heat, or the like.

In a case where hydrogen is used as the fuel, a combustion reaction of hydrogen as shown in Scheme 1 below may occur.

2H₂(g)+O₂(g)→2H₂O(I)ΔH=−572 kJ/mol [Scheme 1]

On the other hand, in a case where hydrocarbons are used as the fuel, a combustion reaction of hydrocarbons as shown in Scheme 2 below may occur.

CₓH_{y}(g)+(x+y/4)O₂(g)→xCO₂(g)+y/2H₂O(I) [Scheme 2]

The first region 11 may contain a first catalyst 113 for the combustion reaction of the fuel. The first catalyst 113 is not particularly limited and may be, for example, a platinum (Pt) catalyst. In addition, although the first catalyst 113 is illustrated in the form of a packed bed in FIG. 1, the present invention is not limited thereto. The first catalyst 113 may exist in any form so long as the first catalyst 113 can come in contact with the fuel.

The combustion reaction of the fuel is an exothermic reaction, and heat generated therefrom is transferred to a hydrogen extraction reaction in the second region 12. Specifically, the heat generated in the first region 11 is transferred to the second region 12 through the partition wall 20. The partition wall 20 is made of a material having a high thermal conductivity, which will be described later.

In the second region 12, the hydrogen extraction reaction of a raw material introduced through a raw material inlet 121 occurs. Hydrogen and byproducts generated by the hydrogen extraction reaction are discharged to the outside through a product outlet 122.

The raw material may comprise at least one selected from the group consisting of methane, methanol, ammonia, liquid organic hydrogen carrier (LOHC), and combinations thereof.

The hydrogen extraction reaction may comprise at least one selected from the group consisting of methane reforming, methanol reforming, ammonia decomposition, liquid organic hydrogen carrier (LOHC) dehydrogenation, and combinations thereof.

A reactant such as carbon dioxide for use in the hydrogen extraction reaction may be introduced into the second region 12 together with the raw material.

All of the above-mentioned hydrogen extraction reactions are endothermic reactions. As an example, the ammonia decomposition is shown in Scheme 3 below.

2NH₃(g)→3H₂(g)+N₂(g)ΔH=46 kJ/mol [Scheme 3]

High heat is required so that the hydrogen extraction reaction proceeds in the forward direction. The present invention is characterized in that the heat generated in the first region 11 is effectively transferred to the second region 12 to increase efficiency of the hydrogen production reactor 1.

A temperature in the second region 12 is not particularly limited and may be, for example, 200° C. to 800° C. The temperature in the second region 12 may be adjusted to 500° C. to 800° C. in a case where the hydrogen extraction reaction is methane reforming or ammonia decomposition, and may be adjusted to 200° C. to 400° C. in a case where the hydrogen extraction reaction is methanol reforming or liquid organic hydrogen carrier (LOHC) dehydrogenation.

The second region 12 may contain a second catalyst 123 for the hydrogen extraction reaction of the raw material. The second catalyst 123 is not particularly limited and may be one in which, for example, a catalytic metal such as ruthenium (Ru) or lanthanum (La) is supported on a support such as alumina (Al₂O₃). In addition, although the second catalyst 123 is illustrated in the form of a packed bed in FIG. 1, the present invention is not limited thereto. The second catalyst 123 may exist in any form so long as the second catalyst 123 can come in contact with the raw material.

The first region 11 and the second region 12 may be spatially separated by the partition wall 20. The heat generated in the first region 11 is transferred to the second region 12 through the partition wall 20, which will be described in detail later.

The hydrogen production reactor 1 may further comprise a circulation flow channel (not shown) for supplying a portion of the hydrogen generated in the second region 12 to the first region 11. Circulation of energy flow in the hydrogen production reactor 1 itself may further improve hydrogen production efficiency.

In addition, the hydrogen production reactor 1 may further comprise a heat-insulating member (not shown) for insulating the reactor from an outside thereof. The housing 10 may be formed of a heat-insulating material to omit the heat-insulating member. This is to prevent a drop in hydrogen production efficiency caused by outward leakage of internal heat, which occurs because the hydrogen production reactor is operated at a high temperature.

FIG. 2 illustrates a second embodiment of a hydrogen production reactor according to the present invention. Referring to this drawing, a hydrogen production reactor 1 may have a double-tube structure having an inner tube 30 and an outer tube 40, wherein the inner tube 30 comprises a first region 31 and the outer tube 40 comprises a second region 41.

The first region 31 is a space in which a combustion reaction of fuel occurs, and the second region 41 is a space in which a hydrogen extraction reaction of a raw material occurs.

Specifically, fuel introduced into the inner tube 30 through a fuel inlet 32 is combusted in the first region 31. Combustion products generated by the combustion of the fuel are discharged to the outside through a fuel outlet 33.

The fuel and the combustion reaction of the fuel have been described above, and thus the description thereof will be omitted below.

The first region 31 may contain a first catalyst 34 for the combustion reaction of the fuel. The first catalyst 34 is not particularly limited and may be, for example, a platinum (Pt) catalyst. In addition, although the first catalyst 34 is illustrated in the form of a packed bed in FIG. 2, the present invention is not limited thereto. The first catalyst 34 may exist in any form so long as the first catalyst 34 can come in contact with the fuel.

Heat generated by the combustion reaction of the fuel is transferred to the second region 41 through the inner tube 30. The inner tube 30 is made of a material having a high thermal conductivity, which will be described later.

In the second region 41, the hydrogen extraction reaction of a raw material introduced through a raw material inlet 42 occurs. Hydrogen and byproducts generated by the hydrogen extraction reaction are discharged to the outside through a product outlet 43.

The raw material and the hydrogen extraction reaction of the raw material have been described above, and thus the description thereof will be omitted below.

A temperature in the second region 41 is not particularly limited and may be, for example, 200° C. to 800° C. The temperature in the second region 41 may be adjusted to 500° C. to 800° C. in a case where the hydrogen extraction reaction is methane reforming or ammonia decomposition, and may be adjusted to 200° C. to 400° C. in a case where the hydrogen extraction reaction is methanol reforming or liquid organic hydrogen carrier (LOHC) dehydrogenation.

The second region 41 may contain a second catalyst 44 for the hydrogen extraction reaction of the raw material. The second catalyst 44 is not particularly limited and may be one in which, for example, a catalytic metal such as ruthenium (Ru) or lanthanum (La) is supported on a support such as alumina (Al₂O₃). In addition, although the second catalyst 44 is illustrated in the form of a packed bed in FIG. 2, the present invention is not limited thereto. The second catalyst 44 may exist in any form so long as the second catalyst 44 can come in contact with the raw material.

The first region 31 and the second region 42 may be spatially separated by the inner tube 30. The heat generated in the first region 31 is transferred to the second region 42 through the inner tube 30, which will be described in detail later.

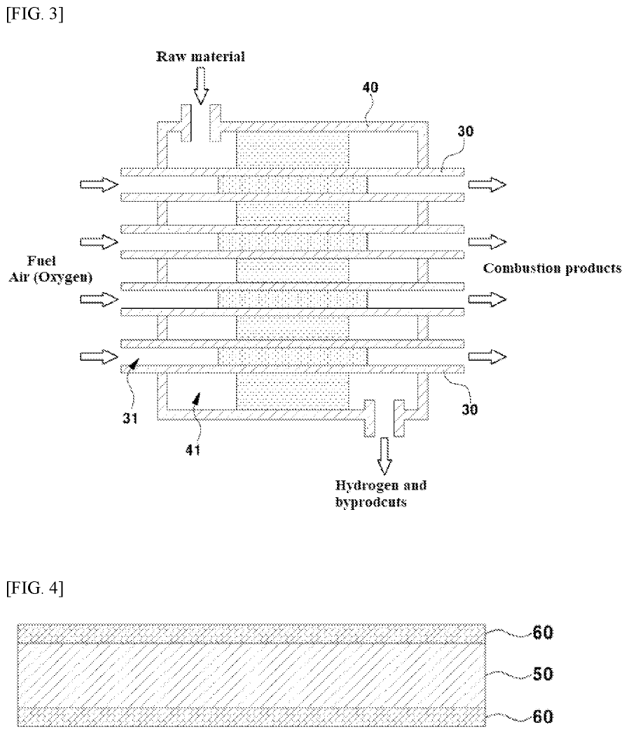

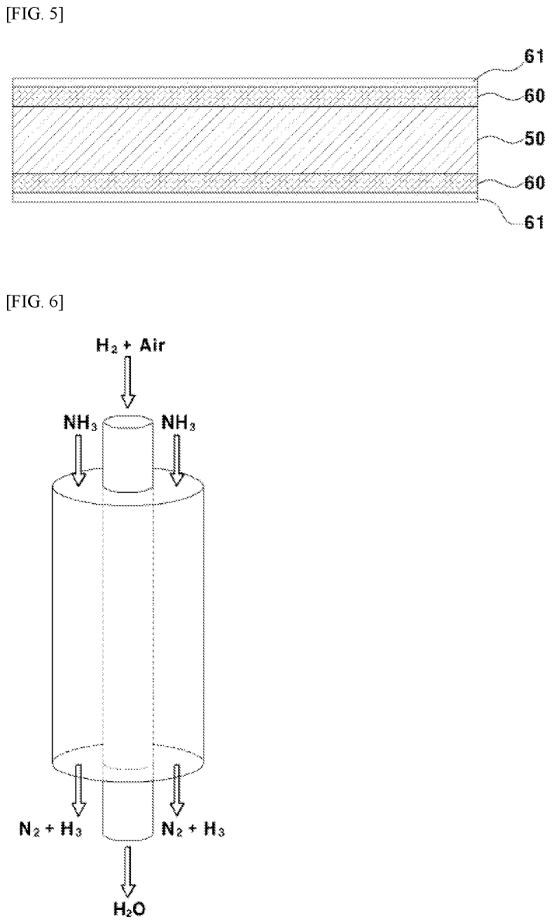

FIG. 3 illustrates a third embodiment of a hydrogen production reactor according to the present invention. Referring to this drawing, a hydrogen production reactor 1 may be a reactor having a multi-tube structure in which a plurality of inner tubes 30, each comprising a first region 31, are provided in an outer tube 40 comprising a second region 41. Other than that, this hydrogen production reactor has the same configuration, function, and the like as the hydrogen production reactor of the second embodiment as described above, and thus the detailed description thereof will be omitted below.

As described above, various types of the hydrogen production reactor according to the present invention are implemented for the purpose of effectively transferring the heat generated in the first region in which the combustion reaction of the fuel occurs to the second region in which the hydrogen extraction reaction of the raw material occurs. Specifically, the heat is transferred through the partition wall 20 in the first embodiment, and through the inner tube 30 in the second and third embodiments.

The present invention is characterized in that a metal substrate having a high thermal conductivity is used as the partition wall 20 and the inner tube 30, wherein a coating layer comprising boron nitride (BN) is formed on at least one surface of the metal substrate.

FIG. 4 illustrates a metal substrate 50 and a coating layer 60 formed on the metal substrate. The metal substrate 50 and the coating layer 60 may constitute all or part of the partition wall 20 or all or part of the inner tube 30.

The metal substrate 50 may comprise a material having a high thermal conductivity and a high melting point, and may specifically comprise at least one selected from the group consisting of copper (Cu), aluminum (Al), tungsten (W), iron (Fe), Inconel, and combinations thereof.

Due to having a high thermal conductivity, the metal substrate 50 is advantageous in transferring the heat generated in the first region to the second region. However, the metal substrate 50 is easily oxidized, which may cause a remarkable decrease in durability of the hydrogen production reactor. To avoid this problem, the present invention has a technical feature that the coating layer 60 comprising boron nitride (BN) is formed on at least one surface of the metal substrate 50.

Due to having a very high thermal conductivity, the boron nitride (BN) can maintain a high thermal conductivity even in a case of being coated on the metal substrate 50.

In addition, the boron nitride (BN) is stable and less reactive at a high temperature, and thus makes it possible to further increase the durability of the reactor.

In addition, since the metal substrate 50 may be brittle to hydrogen, the boron nitride (BN) can be coated on the metal substrate 50 so that molecular hydrogen does not come in contact with the metal substrate 50, thereby causing the hydrogen extraction reaction to occur stably in the second region.

The type of boron nitride (BN) is not particularly limited and may be one having, for example, a hexagonal crystal structure, a cubic crystal structure, or a wurtzite crystal structure.

The coating layer 60 may have a thickness of 1 μm to 10 μm. In a case where the thickness is less than 1 μm, it may be difficult to achieve the purpose of protecting the metal substrate 50. In addition, in a case where the thickness is greater than 10 μm, heat conduction may not be performed smoothly.

A method of preparing the coating layer 60 is not particularly limited, and the coating layer 60 may be formed by, for example, applying or depositing boron nitride (BN) onto the metal substrate 50.

The coating layer 60 may also serve as a type of support for the catalyst for the combustion reaction of the fuel or the hydrogen extraction reaction.

Specifically, as illustrated in FIG. 5, each of catalyst layers 61 and 61′ may be formed by applying the catalyst onto the coating layer 60. Here, the catalyst layer 61′ on the side of the first region may comprise the first catalyst for the combustion reaction of the fuel, and the catalyst layer 61 on the side of the second region may comprise the second catalyst for the hydrogen extraction reaction.

Each of the first catalyst and the second catalyst may be one in which a catalytic metal is supported on a support.

The catalytic metal may comprise at least one selected from the group consisting of ruthenium (Ru), lanthanum (La), platinum (Pt), palladium (Pd), nickel (Ni), iron (Fe), cobalt (Co), and combinations thereof.

The support may comprise at least one selected from the group consisting of alumina (Al₂O₃), graphite, carbon black, and combinations thereof.

The coating layer 60 may comprise at least one of the catalyst layer 61′ on the side of the first region and the catalyst layer 61 on the side of the second region.

A method of forming the catalyst layers 61 and 61′ is not particularly limited, and each of the catalyst layers 61 and 61′ may be formed by applying a slurry containing the catalyst onto the coating layer 60 or depositing the catalyst onto the coating layer 60.

Meanwhile, the catalyst may be supported on boron nitride (BN) of the coating layer 60 or mixed with the boron nitride (BN), rather than be formed as a series of layers. In this case, the catalyst may exist in a form contained in the coating layer 60.

### Preparation Example 1

A hydrogen production reactor having a double-tube structure as illustrated in FIG. 6 was prepared. A copper (Cu) tube was used for an inner tube, and a quartz tube was used for an outer tube. Paint containing boron nitride (BN) was coated on the outer and inner surfaces of the copper tube, and then heat treatment was performed to form coating layers.

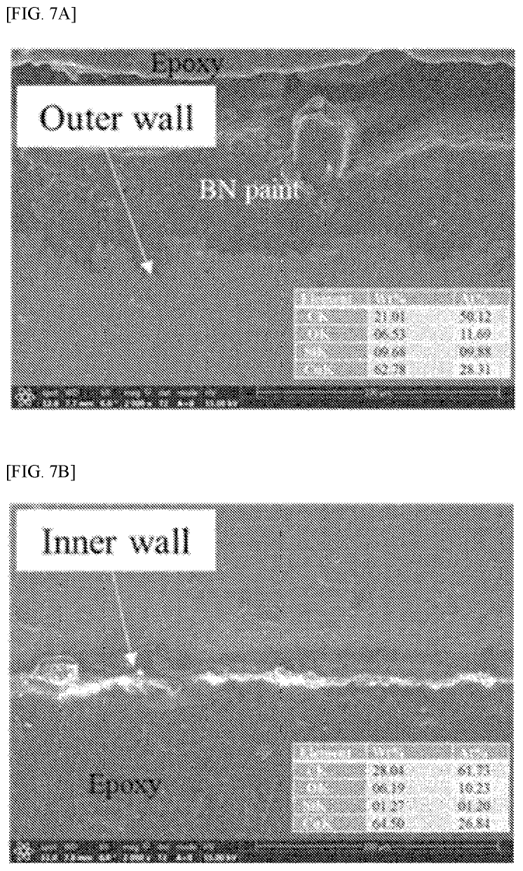

FIG. 7A illustrates a result obtained by performing scanning electron microscope analysis on the outer surface of the copper tube on which the coating layer is formed, and FIG. 7B illustrates a result obtained by performing scanning electron microscope analysis on the inner surface of the copper tube on which the coating layer is formed. Referring to these drawings, it can be seen that the coating layer containing boron nitride has been properly formed on each of the outer and inner surfaces of the copper tube.

### Preparation Example 2

A hydrogen production reactor was prepared in the same manner as in Preparation Example 1, except that when paint containing boron nitride (BN) was coated on the outer surface of the copper tube, the coating was performed using the paint with which a catalyst was further mixed. As the catalyst, a catalyst in which ruthenium (Ru) is supported on alumina (Al₂O₃) was used.

### Comparative Preparation Example

A hydrogen production reactor was prepared as in Preparation Example 1, except that the coating layer was not formed on the copper tube.

### Experimental Example

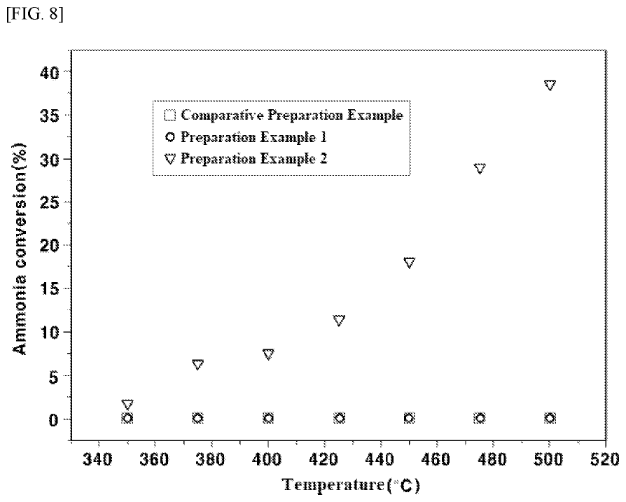

Ammonia conversion rates were measured in the hydrogen production reactors according to Preparation Example 1, Preparation Example 2, and Comparative Preparation Example while causing ammonia decomposition to produce hydrogen. The results are illustrated in FIG. 8. Referring to this drawing, it can be seen that for the hydrogen production reactor according to Preparation Example 2 in which the catalyst having activity for ammonia decomposition is included in the outer surface of the copper tube, its ammonia conversion rate reached 40%.

Although non-limiting and exemplary embodiments of the present invention have been described above, the technical spirit of the present invention is not limited to the accompanying drawings or the above description. It is apparent to those skilled in the art that various types of modifications can be made within a scope that does not depart from the technical idea of the present invention. In addition, such modifications will fall within the scope of the claims of the present invention.

1. A hydrogen production reactor, comprising:
a first region in which a combustion reaction of fuel occurs;
a second region in which a hydrogen extraction reaction occurs;
a metal substrate that partitions the first region and the second region; and
a coating layer that comprises boron nitride (BN) and is adjacent to at least one surface of the metal substrate,
wherein heat generated in the first region is transferred to the second region through the metal substrate, and
the at least one surface of the metal substrate comprises a surface facing the second region.

2. The hydrogen production reactor of claim 1, further comprising:
a housing inside which the first region and the second region are provided; and
a partition wall that partitions the first region and the second region, wherein the partition wall comprises the metal substrate, and is provided inside the housing.

3. The hydrogen production reactor of claim 1, wherein the hydrogen production reactor comprises a double-tube structure having an inner tube and an outer tube, wherein
the inner tube comprises the first region and the outer tube comprises the second region.

4. The hydrogen production reactor of claim 3, wherein the hydrogen production reactor comprises a plurality of the inner tubes.

5. The hydrogen production reactor of claim 1, wherein the fuel comprises at least one member selected from the group consisting of hydrogen, hydrocarbons, and combinations thereof.

6. The hydrogen production reactor of claim 1, wherein the first region comprises a catalyst for the combustion reaction of the fuel.

7. The hydrogen production reactor of claim 1, wherein the hydrogen extraction reaction comprises at least one member selected from the group consisting of methane reforming, methanol reforming, ammonia decomposition, liquid organic hydrogen carrier (LOHC) dehydrogenation, and combinations thereof.

8. The hydrogen production reactor of claim 1, wherein the second region comprises a catalyst for the hydrogen extraction reaction.

9. The hydrogen production reactor of claim 1, wherein a temperature in the second region comprises a range of 200° C. to 800° C.

10. The hydrogen production reactor of claim 1, wherein the metal substrate comprises at least member one selected from the group consisting of copper (Cu), aluminum (Al), tungsten (W), iron (Fe), Inconel, and combinations thereof.

11. The hydrogen production reactor of claim 1, wherein the coating layer has a thickness of from 1 micrometer (μm) to 10 μm.

12. The hydrogen production reactor of claim 1, wherein the coating layer further comprises a catalyst for the combustion reaction of the fuel or the hydrogen extraction reaction.

13. The hydrogen production reactor of claim 12, wherein the catalyst is applied onto the coating layer to form a catalyst layer.

14. The hydrogen production reactor of claim 12, wherein the catalyst is adjacent to the boron nitride of the coating layer.

15. The hydrogen production reactor of claim 12, wherein the catalyst comprises at least one catalytic metal selected from the group consisting of ruthenium (Ru), lanthanum (La), platinum (Pt), palladium (Pd), nickel (Ni), iron (Fe), cobalt (Co), and combinations thereof.

16. The hydrogen production reactor of claim 1, further comprising:
a circulation flow channel for supplying hydrogen generated in the second region to the first region.

17. The hydrogen production reactor of claim 1, further comprising:
a heat-insulating member for insulating the hydrogen production reactor from an outside thereof.

18. The hydrogen production reactor of claim 1, wherein the metal substrate comprises at least one member selected from the group consisting of copper (Cu), aluminum (Al), tungsten (W), iron (Fe), Inconel, and combinations thereof,
wherein the coating layer further comprises a catalyst for the combustion reaction of the fuel or the hydrogen extraction reaction, and
wherein the catalyst is adjacent to the boron nitride of the coating layer.

19. A hydrogen production reactor, comprising:
a first region in which a combustion reaction of fuel occurs;
a second region in which a hydrogen extraction reaction occurs;
a metal substrate that partitions the first region and the second region; and
a coating layer that comprises boron nitride (BN) and is adjacent to at least one surface of the metal substrate,
wherein heat generated in the first region is transferred to the second region through the metal substrate,
wherein the coating layer further comprises a catalyst for the combustion reaction of the fuel or the hydrogen extraction reaction, and
wherein the catalyst is adjacent to the boron nitride of the coating layer.

20. A method of hydrogen production in a hydrogen production reactor, comprising:
combusting a fuel in a first region of the hydrogen production reactor; and
extracting hydrogen in a second region of the hydrogen production reactor,
wherein a metal substrate partitions the first region and the second region,
wherein a coating layer comprising boron nitride (BN) is adjacent to at least one surface of the metal substrate,
wherein heat generated in the first region is transferred to the second region through the metal substrate,
wherein the at least one surface of the metal substrate comprises a surface facing the second region.
